(19) United States
(12) Patent Application Publication
(10) Pub. No.: US 2013/0081992 A1
(43) Pub. Date: Apr. 4, 2013

(54) Low pressure water filter cassette

(71) Applicant: Liquidity Inc, Alameda, CA (US)

(72) Inventors: Sylvie Chavanne, Walnut Creek, CA (US); Michael Hawes, Oakland, CA (US)

(73) Assignee: LIQUIDITY INC, Alameda, CA (US)

(21) Appl. No.: 13/573,555

(22) Filed: Sep. 24, 2012

Related U.S. Application Data
(60) Provisional application No. 61/538,665, filed on Sep. 23, 2011.

(51) Int. Cl. B01D 27/14; C02F 1/00; B01D 29/00

(52) U.S. Cl. CPC B01D 27/14; B01D 29/0095; C02F 1/001
USPC 210/323.1; 210/435

(57) ABSTRACT

A water filter cassette for use in a gravity-fed household water filtration system. The cassette is comprised of a series of planar rectangular frames each frame adapted for filtration of a particular contaminant.

### FIELD OF THE INVENTION

The invention relates generally to water filters suitable for removal of bacterial and/or viral and other types of contamination. More particularly the invention relates to water filtering devices with a gravity feed of less than 3 feet water head. Most particularly the invention relates to a gravity feed water filtering cassette device adapted for use with one or more contaminant-specific frames for use in a home filtration system wherein the cassette comprises one or more substantially flat (planar) frames arranged in sequence in the device and perpendicular to the flow of water.

### BACKGROUND OF THE INVENTION

Pressurized water filtration with regard to bacterial contamination can be accomplished by various methods. See, eg, Morgart, et al., U.S. Pat. No. 5,242,595 Bacterial Removal by Ceramic Microfiltration Sep. 7, 1993; Shiraiwa, et al., U.S. Pat. No. 6,443,314, Sep. 3, 2002 Membrane Filtration System.

The flux of standard filter materials is too low at low pressure or gravity to be of practical use for microbial removal especially removal of bacteria, therefore most water filtration applications use pressure to reach the desired flow rate. Pressurizing the filter places physical limitations on the structural integrity of the media and the pressure vessel employed. Pressurizing the filter may also require an energy source. Finally, while desirable for reasons discussed below, a flat structure is more difficult to support mechanically and consequently a cylindrical media geometry is usually employed. See for example Kamei et al U.S. Pat. No. 4,869,822 Jun. 26, 1989 Filter Apparatus Employing Hollow Fibers.

New media technology provides media with greater flux. See eg, Wang et al. US Pub No. 2011/0210062, Method of Making a Filter Media with an Enriched Binder Sep. 1, 2011; Schroeder et al. U.S. Pat. No. 8,002,990 Uses of Fibrillated Nanofibers and the Removal of Soluble, Colloidal, and Insoluble Particles from a Fluid Aug. 23, 2011. Cationic charge modified filter media for removal of anionically charged contaminants such as viruses is also known (See, Ostreicher, E. A. Use of Cationic Charge Modified Filter Media U.S. Pat. No. 5,085,780, issued Feb. 4, 1992)

### SUMMARY OF THE INVENTION

Disclosed herein is a gravity-fed water filter device useful as a removable and replaceable cassette in a home water purification system. The filter itself comprises: a) a sequential series of substantially planar filtration frames, each frame comprising filter media located between two opposing trays and two opposing plates, the plates and trays oriented rectangularly and defining an internal space, and the media provided within the internal space. The series of frames comprise the body of the device, wherein each frame is located such that the plane of the frame is perpendicular to the flow of the water stream and each of the frames adapted for filtration of a selected class of contaminant; b) a first endplate located upstream of and adjacent to a first filtration frame and adapted to receive inflow of contaminated water; c) and a second endplate located downstream of and adjacent to a last filtration frame and adapted to expel purified water; and wherein the first and second endplates and the frames are adapted to retain water within the filter device. The inflowing water passes through the first endplate, is filtered by the frames to remove selected contaminants, passes out through the second endplate. Preferably, the outflowing filtered water is expelled with a flow rate of 5-250 ml/min, and the microbial contaminant load is reduced 6 orders of magnitude for bacterial contaminants and 4 orders of magnitude for the viral contaminants.

Each frame comprises one or more filter media. The media are sealed within opposing first and second trays and opposing first and second plates, the plates and trays configured rectangularly and defining an interior and exterior space. The trays and plates of one frame are sealed to the trays and plates of the next frame preventing leakage of fluid from the interior of the frame to the exterior. The media is sealed within the frame such that there is no leakage of fluid between the media edges and the trays or plates. Each frame is adapted for filtration of a particular class of contaminant. Typically, a first frame serves as a prefilter to remove insoluble and particulate matter. In a preferred embodiment a first frame is adapted for filtration of insoluble particulate matter, a second frame is adapted for removal of bacterial contamination and a third frame is adapted for removal of viral contamination. In other embodiments if desired, additional frames are substituted or provided for removal of heavy metals, organic, or other contamination.

### DESCRIPTION OF THE DRAWINGS

FIG. 1—Low pressure water filter cassette comprising 3 modular frames and indicating the intended direction of flow.

FIG. 2—A modular frame with a pleated medium.

FIG. 3—A detail of the corners of two frames.

FIG. 4—An expanded view of a frame.

FIG. 5—An expanded view of a 3-frame cassette.

FIG. 6—A-A water purification system comprising a source reservoir, filter cassettes oriented horizontally, and clean water reservoir.

B-A water purification system comprising a source reservoir, filter cassettes oriented vertically, and clean water reservoir.

### DETAILED DESCRIPTION OF THE INVENTION

### Definitions:

“Cassette” as used herein refers to the removeable and exchangeable water filter unit itself, or in the context of a filtration system comprising a contaminated water source, a purified water source, a piping system connecting them, and the replaceable, removable cassette filter unit located in-line and therebetween.

“Medium” or “media” as used herein refer to the filter material used in each of the modular frames of the cassette and internal to the perimeter of the frame.

“Frame” as used herein refers to the modular component forming the body of the filter. The frame comprises two trays and two plates oriented generally rectangularly and defines an interior space into which a filter medium or media is sealed. Frames are assembled one to the other such that there is no leakage of water between the edge of the media and the frame or from the interior of the frame to the exterior.

“Microbial” as used herein refers to biologic contamination, particularly bacterial and/or viral.

“Modular” as used herein refers to the flexible aspect of the filter cassette which allows for assembly and manufacture of filters using different numbers of frames, different order of frames with regard to contaminant specificity, and different surface area of the media within each frame.

“Planar” as used herein refers to a substantially flat configuration of the frames wherein the thickness of each frame is small relative to the length or width of the frame and in which the mass flow of water through the media in each frame is substantially in the same direction as the overall flow of water through the cassette, and perpendicular to the plane of the frame. This contrasts with a cylindrical configuration in which water flows in a radial fashion from inner to outer or outer to inner as defined by the media of the cylinder. Contemplated within this definition are filtration media which are flat and perpendicular to the overall flow of the filter as well as media which are pleated in the tray.

Disclosed herein is a low pressure water filter 10 useful as a removable and replaceable cassette in a home water purification system. Typically, contaminated source or input water is gathered from a well, rain water catchment, community water source, municipal (mains) water or the like and may be stored in an upper reservoir 20. An inventive aspect of the cassette filter is that the source water feeds by gravity to the cassette filter with a water head differential of less than about 3 feet of water head. In this system the flux across the media provided is at least 0.02 but no more than 0.25 ml/min/sq cm of filter material area, per cm head height of incoming water pressure. For comparison to a pressurised input of, for example, 350 kPa (which would be equivalent to 35.7 metres of water head), the flow would be 356 to 892 ml/min/sq cm of filter area. Regarding the flow rate of the cassette, it could be expressed as 50 to 250 ml/min from a cassette whose total volume is between 100 and 400 cubic cm. Other systems require far greater pressure to achieve an acceptable flux. In an embodiment, the cassette filter 10 (FIG. 3) has been inserted in-line on the outflow from the source reservoir. The outflow from the filter cassette then proceeds to a purified household water source such as a spigot, or alternatively, to a purified water storage reservoir 30 and then to a spigot for consumption. The cassette filter may be adapted to many locations in relation to the source and purified water reservoirs, including the inside of the source reservoir at the outlet port, the inside of the clean water reservoir at the input port or inline there between, whether physically in contact with the reservoirs walls or not. It can also be adapted to be at the end of a tube from the source reservoir when a storage (collection) reservoir is not used.

At the flow rate disclosed, the cassette reduces bacteria by log 6 and virus by log 4 (See Example 2).

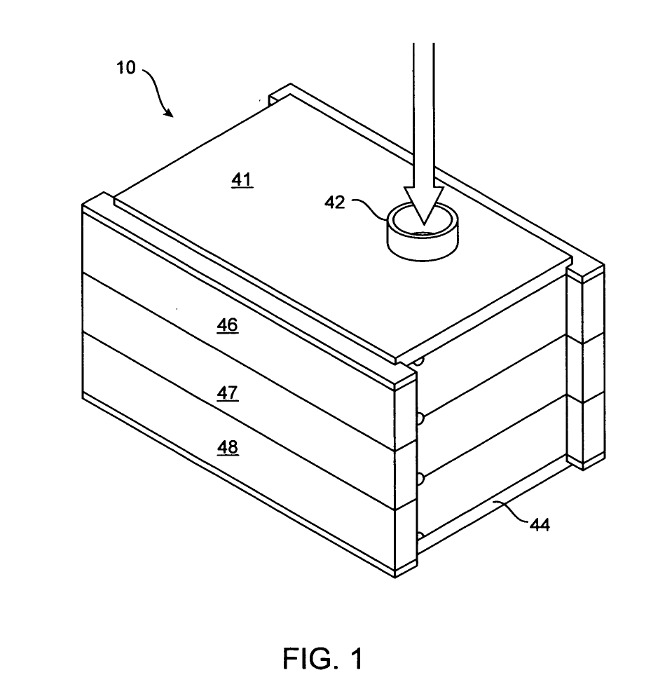

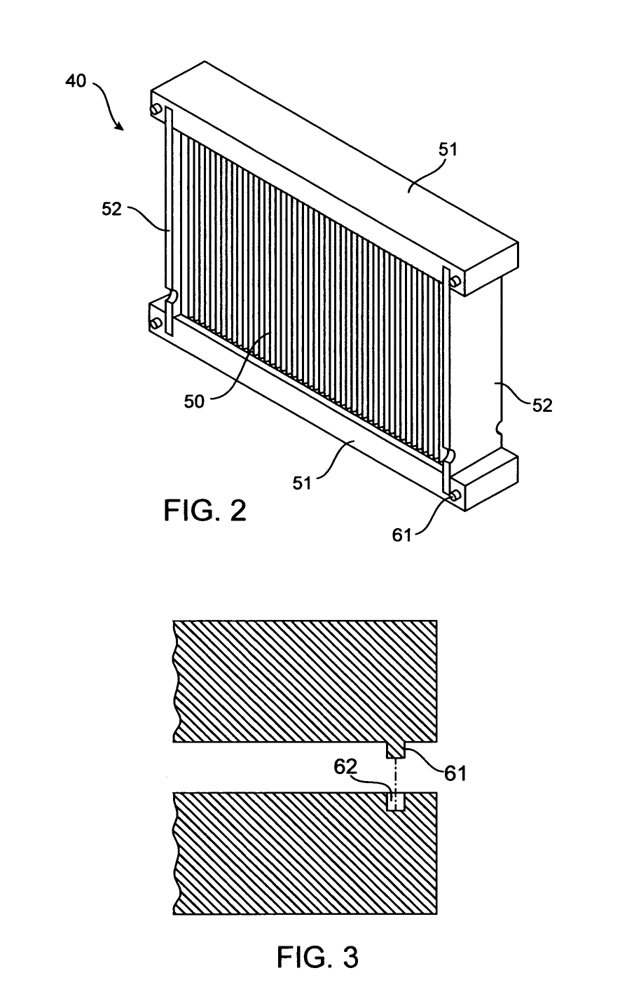

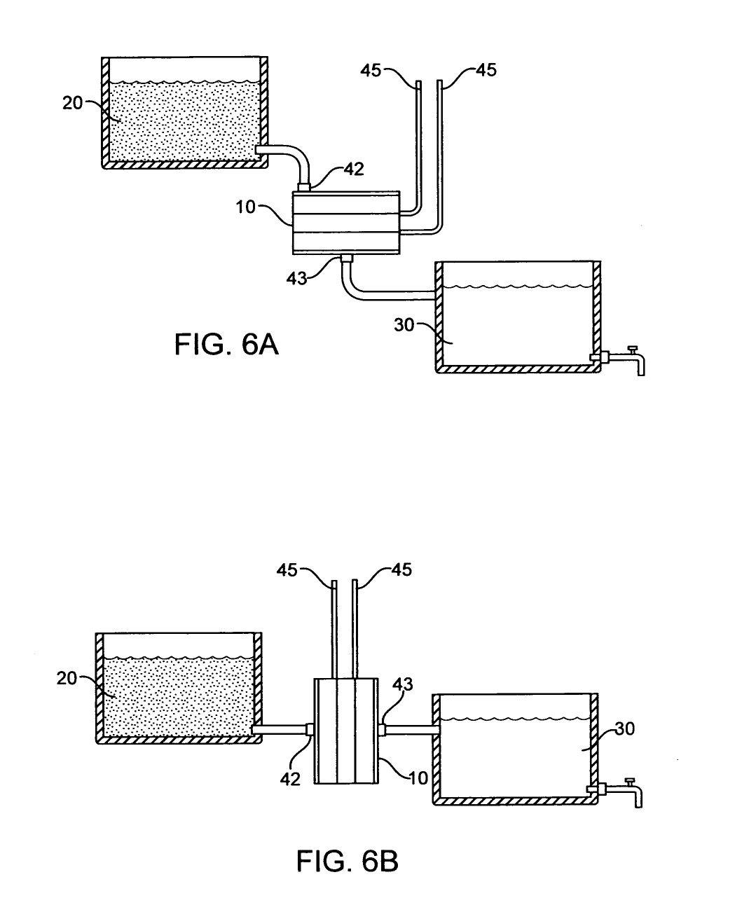

The Cassette: Turning now to FIG. 1, the cassette filter 10 comprises: a) a sequential series of two or more planar filtration frames 40 (FIG. 2), where each frame is adapted for filtration of a selected class of contaminant; b) a first endplate 41 located upstream of and adjacent to a first filtration frame and adapted to receive water inflow through an input port 42; c) and a second end plate 44 located downstream of and adjacent to a last filtration frame and adapted to expel water outflow though an output port 43 (FIG. 6); wherein inflowing water is filtered to remove selected contaminants.

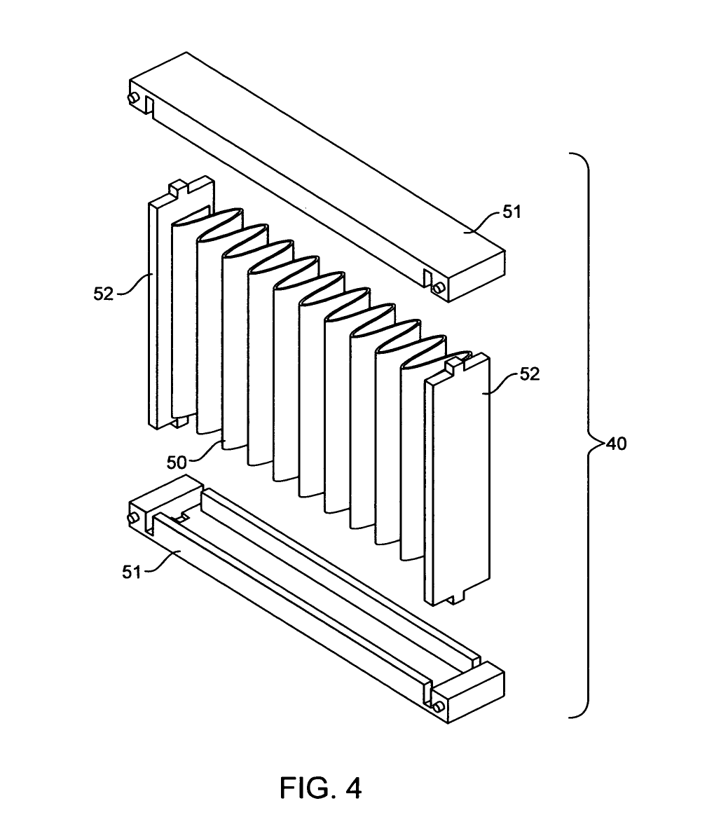

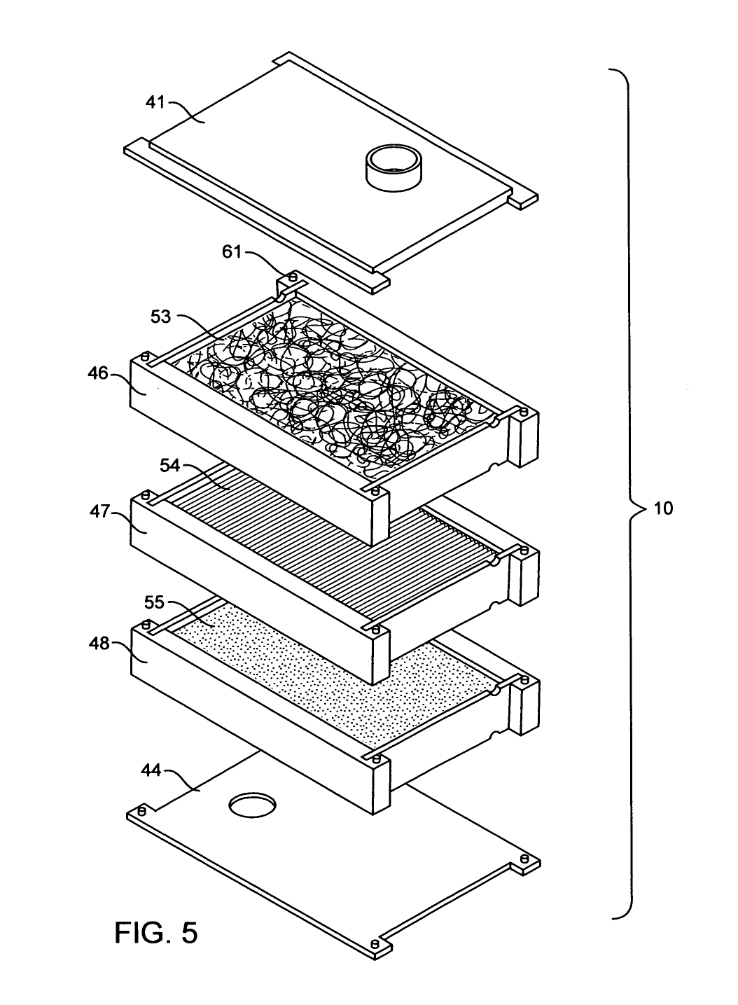

Turning now to FIGS. 2 and 4, each frame comprises one or more filter media 50, an opposing pair of trays 51 and an opposing pair of plates 52, the 4 of which forming a rectangle which surrounds the media 50 and into which the media is sealed such that there is no leakage of water between the media edges and the trays and plates. When the cassette is assembled the frames are sealed to each other and to the endplates such that there is no seepage or leakage from the interior of the frame(s), between the frames or a frame and an endplate to the exterior of the frame(s) and cassette. The planar and rectanglular geometry of each frame and the modular arrangement of the frames relative to each other in the cassette allow for maximum flexibility in terms of the type of filtration, the number of classes of contamination that are removed and the relative surface areas of the media in each frame.

The configuration of the cassette in the system permits horizontal (FIG. 6A) or vertical (FIG. 6B) orientation of the frames of the cassette, or any orientation between horizontal and vertical, but always such that the frames are perpendicular to the flow of water.

Turning now to FIG. 5, assembly of the frame modules 46 through 48 into the cassette filter is accomplished by placement of the frames adjacent to each other and sandwiched by a first endplate 41 at the input end and a second endplate 44 at the output end. The frames and endplates are attached one to the next by glue, hot melt, over molding or sonic welding such that the watertight body of the cassette is formed by the trays and plates of the frames, and the two endplates, sealed to each other, such that there is no leakage of water from the interior of the cassette to the exterior.

As shown in FIG. 6, each endplate is adapted so that the cassette fits into the system such that the cassette is easily removable when, for instance the filter needs to be changed. Preferably, when the filter is introduced in the filtration system, the inlet 42 outlet 43 and vents 45 (discussed below) connect automatically to their corresponding ports, within the filtration system. Preferably, when the filter is removed, these ports automatically shut-off via their valve so the water does not drip or flow out of the filtration system.

The inlet port 42 and outlet port 43 are located on the end plates 41 and 44 in a location suitable for the design of the system and the way in which the cassette is received within the system. The inlets and outlets may be large enough to allow proper venting, or additional vents 45 may be incorporated. When several frames are used, vents 45 have been designed, in between each frame to prevent air locking. The vents are located towards the cassette top, and suitable for the design of the system and orientation of the cassette within the system.

Frames and Media: With the exception of media, all parts of the cassette frame (trays and plates) and end plates are made from polymer such as polypropylene, polystyrene, acrylonitrile butadiene styrene, polycarbonate, polymethyl-methacrylate, polyethylene terephthalate, polyurethane, cross-linked forms thereof, derivatives thereof, copolymers thereof, and combinations thereof. As shown in FIG. 3, the end plates and frames of the cassette have a tooth or pin 61 at each end with a matching complimentary shape or pinhole 62 in the adjacent frame or endplate to facilitate alignments of the end plates and adjacent frame when assembled. If pins are used, they can be made in metal or plastic. The assembly of the frames and their attachment to each other and to the end plates constitutes the constructive housing of the cassette. In other words, the end plates and perimeter of the assembled frames (trays 51 and plates 52) define the housing per se. Adding more frames can be done very easily and does not require any differently designed frame parts other than the desired media.

Turning now to an embodiment shown in FIG. 5, multipe frames can be assembled in the cassette and each frame may contain one or more layers of media adapted for effective filtration of a particular contaminant. When multiple layers are used in one frame, they can be identical or different (see section below for actual description of the layers) as a function of their purpose, performances needed and technology used. They can be matrix media 53, substantially flat media 55 or pleated media 54 known in the art. From one frame to the next, the surface area can be the same or different. As discussed above, such flexibility is hard to achieve in a more standard cylindrical filter format.

Following are examples of the following types and combinations of media useful in each frame of the cassette. The first frame 46 is typically a prefilter for removal of insoluble and particulate material and preferably is a matrix media 53 and may have multiple layers. These layers may be non woven or woven media, scaffold. The materials used for these layers can be polyolefins, polysulfones, polyethersulfones, fluoropolymers, polyvinylidene fluorides, polyesters, polyamides, polycarbonates, polystyrenes, polyacrylonitriles, poly(meth)acrylates, polyvinylacetates, polyvinyl alcohols, polysaccharides, cellulose, chitosan, chitin, hyaluronic acid, proteins, polyalkylene oxides, polyurethanes, polyureas, polyvinyl chlorides, polyimines, polyvinylpyrrolidones, polyacrylic acids, polymethacrylic acids, polysiloxanes, poly (ester-co-glycol) polymers, poly(ether-co-amide) polymers, cross-linked forms thereof, derivatives thereof, copolymers thereof, and combinations thereof or glass fiber. One or multiple layers can be used, flat or pleated, and the layers may be modified by surface chemistry such as charge modification polymers. Typically, a layer of larger pore size is place upstream of a layer of smaller port size, providing for optimum particulate filtration, but the reverse configuration can also be used. The prefilter removes at least 95% of the insoluble and particulate material in the source water, preferably at least 99% and most preferably at least 99.9999% of particles greater than 0.2 micron size.

A second frame 47 may be adapted to be bacteria retentive and may includes microfiltration media of non woven, woven, membrane-like material which can be used, flat or pleated (as shown 54). The media in this frame may be made of the following materials polyolefins, polysulfones, polyethersulfones, fluoropolymers, polyvinylidene fluorides, polyesters, polyamides, polycarbonates, polystyrenes, polyacrylonitriles, poly(meth)acrylates, polyvinylacetates, polyvinyl alcohols, polysaccharides, cellulose, chitosan, chitin, hyaluronic acid, proteins, polyalkylene oxides, polyurethanes, polyureas, polyvinyl chlorides, polyimines, polyvinylpyrrolidones, polyacrylic acids, polymethacrylic acids, polysiloxanes, poly (ester-co-glycol) polymers, poly(ether-co-amide) polymers, cross-linked forms thereof, derivatives thereof, copolymers thereof, and combinations thereof or glass fiber. One or multiple layers can be used, flat or pleated, and the layers may be modified by surface chemistry such as charge modification polymers.

A virus retentive frame 48 is depicted and may include media of non woven, woven, membrane media which can be used flat (shown 55) or pleated. The materials used for these layers can be polyolefins, polysulfones, polyethersulfones, fluoropolymers, polyvinylidene fluorides, polyesters, polyamides, polycarbonates, polystyrenes, polyacrylonitriles, poly(meth)acrylates, polyvinylacetates, polyvinyl alcohols, polysaccharides, cellulose, chitosan, chitin, hyaluronic acid, proteins, polyalkylene oxides, polyurethanes, polyureas, polyvinyl chlorides, polyimines, polyvinylpyrrolidones, polyacrylic acids, polymethacrylic acids, polysiloxanes, poly (ester-co-glycol) polymers, poly(ether-co-amide) polymers, cross-linked forms thereof, derivatives thereof, copolymers thereof, and combinations thereof or glass fiber. One or multiple layers can be used, and the layers may be modified by surface chemistry such as charge modification polymers.

Other frames with targeting of other classes of contaminants such as heavy metals or organics may also be used in combination with one or both of those described above or in substitution. Media for these frames include activated carbon (granulated or powder), ion exchange resin (beads or powder), zeolite or other compounds able to capture organic and inorganic compounds by adsorption, charge attraction, reaction and the like. These materials can be loose between 2 holding layers such as non woven or woven, or part of a non woven, woven media, which can be used pleated or flat.

An important feature of this invention is the flexibility of the modular frame approach. This flexibility is due in part to the substantially planar geometry of each frame, permitting thereby assembly without regard to the geometric restrictions imposed by multilayered cylindrical filters. For instance, a cylindrical filter with multiple stages would be unacceptably large in circumference to prevent contact between layers which should not be contacting other layers. The density of pleating in the medium is similarly constrained by structural integrity considerations which limits the variability between layers. Also, the circumference of outer layers in a multi-layered cylindrical filter is necessarily larger than the inner layers, which further limits the configuration of surface areas of the different layers. Utilizing the substantially-planer geometry of the frames, the surface area of the media in each frame can be easily increased or descreased by varying or even eliminating the pleating in the media.

Turning now to FIG. 4, the short ends of the media 50 of each frame 40 are sealed onto two plates 52 which form 2 of the 4 sides of the frame once inserted in the 2 trays 51, both trays forming the other 2 sides of the frame 40. The sealing method can be glue, hot melt, sonic welding, pinching. The remaining unattached edges of the media 50 (along the length of the media) and the attached plates 52 are then sealed into 2 trays 51 (one for each media edge). The sealing method can be potting, hot melt, glue, over molding, pinching or sonic welding. Thus, the two plates 52 and the two trays 51 form the perimeter of one frame 40 with 4 sides.

### EXAMPLES

### Example 1

### Determination of Flux

The flux of a model cassette was measured with water, at room temperature. The filter media were installed in stainless steel holders, connected to one another via tubing to form a filtration train. Each filtration train contained a combination of pre-filter made from glass fiber of different porosity, bacteria retentive layer made from polyacrylonitrile and virus retentive layer made from modified glass fiber. The filtration train was connected to a reservoir containing water. The water level in the reservoir was used to define the water head height and therefore the pressure used during filtration. For each measurement it was set at 14 cm. The stainless steel holders had an effective filtration area of 12.5 cm².

TABLE 1

| | | Flux |
|---|---|---|
| | Flow rate | (ml/min/cm² filter/ |
| Sample ID | (ml/min) | cm head) |
| 050411 | 29.1 | 0.166 |
| 050611-stand 3 | 31.4 | 0.179 |
| 051111-stand 3 | 18 | 0.103 |
| 070811 | 16 | 0.091 |
| 071111 | 24 | 0.137 |
| 092111 | 12 | 0.069 |

The acceptable range is 0.02 to 0.25 ml/min/sq cm of filter material area, per cm head height of incoming water pressure.

For pressurized flux, one would put the appropriate pressure (in cm head height) into the above units. For example, if the pressure head was 10 m of water, then the flow would be 20 to 250 ml/min/sq cm. If it was 20 m head height, the flow would be 40 to 500 ml/min/sq cm. This is equivalent to flow from a complete cassette of between 50 to 250 ml/min, from a cassette whose total volume is between 100 and 400 cubic cm. At this flux and flow rate, the cassette of the present invention reduces bacteria by 6 log and virus by 4 log.

### Example 2

### Measurement of the Reduction of Microbial Load

Cassettes were assembled using 3 frames. The first frame contained the prefilter media constructed with glass fiber, the second frame contained bacteria retentive media comprising microporous polymeric membrane made of polyacrilonitrile laid onto a polyester support fabric, and the third frame contained the virus retentive media comprising a non woven glass fiber media modified with polyamine epichlorohydrin resin. The cassettes were challenged with contaminated water (see table below for contaminants specifics). Each cassette was connected to a reservoir containing the contaminated water. The distance between the maximum water level and the cassette was set at 14 cm (water head). The influent and effluent were collected. The Log Reduction Value (LRV) was calculated for the samples.

| | | Bacteria | |
|---|---|---|---|
| | Flow rate (ml/min) at | (E. Coli or Klebsiella | Virus (MS2) |
| Sample ID | water head 14 cm | Terrigena) LRV | LRV |
| 070711 | 130 | 6 | n/a |
| 072811PU | 180 | n/a | 4.8 |
| 072811EP | 180 | n/a | 4.8 |
| 080811 | 120 | 8 | 4.6 |

In the foregoing, the present invention has been described with reference to suitable embodiments, but these embodiments are only for purposes of understanding the invention and various alterations or modifications are possible so long as the present invention does not deviate from the claims that follow.

What is claimed is:

1. A low pressure water filter, said filter adapted for use as a removable cassette in a household water system with a water source comprising water contaminated with a microbial load, said filter comprising:
a) one or more substantially planar filtration frames, each frame comprising filter media surrounded by an opposing pair of trays and an opposing pair of plates, to each frame adapted for filtration of a selected class or classes of contaminant from a contaminated water supply, wherein said contamination comprises a microbial load, and at least one frame is adapted for microbial filtration;
b) a first endplate located upstream of and adjacent to a first filtration frame and adapted to receive water inflow; and,
c) a second endplate opposing said first endplate located downstream of and adjacent to a last filtration frame and adapted to expel water;
wherein said endplates and frames form a box with an interior space and, said first and second endplates and said filter frames are sealed one to the other to prevent water seepage; wherein each frame comprises at least one filtration medium.

2. The water filter of claim 1 wherein each frame has a surface area of no more than 300 cm².

3. The water filter of claim 2 wherein said low pressure filter has a flow rate of at least 5 ml/min/cm of head pressure.

4. The water filter of claim 3 wherein said water source comprises a bacterial load and said filter achieves at least a 6 log reduction of said bacterial load.

5. The water filter of claim 3 wherein said water source comprises a viral load and said filter achieves at least a 4 log reduction of said viral load.

6. The water filter of claim 3 wherein said water source comprises bacterial and viral load and said filter achieves at least 6 log reduction of said bacterial load and at least a 4 log reduction of said viral load.

7. The water filter of claim 3 for use in a system comprising source water with insoluble or particle matter wherein said filter additionally removes substantially all insoluble or particle matter.

8. The water filter of claim 3 wherein the cassette volume is less than 400 cm³.

9. The water filter of claim 3 additionally adapted to remove heavy metal contamination.

10. The water filter of claim 3 additionally adapted to remove organic contamination.

11. The water filter of claim 3 additionally adapted to remove both heavy metal and organic contamination.

12. A system for purifying a contaminated household water supply comprising:
a) a contaminated water supply;
b) pipes comprising a connection between the contaminated water supply and a purified household water source; and,
c) the water filter of claim 3 integrally located between the contaminated water supply and the purified household water source;
wherein said contaminated water supply passes through said filter by means of gravity flow and is purified thereby, and wherein said purified water then passes to said purified water source.

13. The system of claim 12 additionally comprising a purified water holding tank located between the water filter and the purified household water source.
